(19) United States
(12) Patent Application Publication
(10) Pub. No.: US 2026/0296751 A1
(43) Pub. Date: Oct. 1, 2026

(54) COATING SYSTEM FOR CONTAINERS

(71) Applicant: SWIMC LLC, Cleveland, OH (US)

(72) Inventors: Jean-Dominique TURGIS, Vertou (FR); Delphine DESTAL, Bouaye (FR); Clementine MAURIER, Nantes (FR)

(21) Appl. No.: 19/477,420

(22) PCT Filed: May 10, 2024
(86) PCT No.: PCT/US2024/028725

§ 371 Date: Oct. 21, 2025

Related U.S. Application Data
(60) Provisional application No. 63/501,491, filed on May 11, 2023.

(51) Int. Cl. B65D 65/42; C09D 5/08; C09D 7/40; C09D 7/61

(52) U.S. Cl. CPC B65D 65/42; C09D 5/084; C09D 7/61; C09D 7/66

(57) ABSTRACT

A packaging container, or a portion thereof, comprising a metal substrate, and an interior coating applied on at least a portion of the metal substrate. The interior coating formed from a coating composition including one or more film-forming binder resins and a sulfur-species scavenging particles. The coating compositions protect closures or containers herein from corrosion due to at least sulfur or sulfur dioxide containing species.

### CROSS-REFERENCE TO OTHER APPLICATIONS

This application claims priority to U.S. Provisional Patent Application No. 63/501,491 filed on May 11, 2023, which is incorporated by reference in its entirety.

### FIELD

The present application relates to coating systems for metal containers, and in particular, coating systems for metal containers configured to protect the containers from corrosion.

### BACKGROUND

The application of coatings to metals and/or other substrates to protect the substrate and/or to inhibit corrosion is well established. This is particularly true in the area of architectural coatings as well as in the area of packaging containers such as food or beverage containers and, in particular, for twist-off closures for such packaging containers.

For example, coatings are typically applied to the interior of containers to prevent the container contents from contacting any metal of the container. Contact between the container and the packaged product can, in some instances, lead to corrosion of the metal container or metal container part, which may be undesired for a variety of reasons. Protective coatings are also applied to the interior of closures for food or beverage containers, such as regular ends or easy-open ends, to prevent corrosion in the headspace of the container between the fill line of the food product and the container lid and/or to the inner surfaces of the container closing part. In such instances, container or closure corrosion may be a particular issue when the packaged contents are chemically aggressive in nature.

Packaging coatings should preferably be capable of high-speed application to the substrate and provide desired properties when hardened to perform in this demanding end use. For example, the coating should be safe for food contact, not adversely affect the taste of the packaged food or beverage product, have excellent adhesion to the substrate, resist staining and other coating defects such as “blushing” and/or “blistering,” and resist degradation over long periods of time, even when exposed to harsh environments. In addition, the coating should generally be capable of maintaining suitable film integrity during container and/or closure fabrication and be capable of withstanding the processing conditions that the container and closure may be subjected to during product packaging.

Conventional closures for packaging containers incorporate one or more coatings that are typically derived from physical and/or chemically curable formulations that often include one or more thermoplastic and/or thermosetting resins including, in some instances, vinyl chloride polymers such as polyvinylchloride (PVC) and/or epoxy-derived resins. When these coatings are applied to a substrate and cured, the coatings and/or the coated substrate can degrade and/or discolor under some circumstances. For example, the degradation products from PVC-based coatings or PVC-based gasket material may include hydrochloric acid that can attack and/or discolor the metal substrate forming the closure or food/beverage containers even with prior container coatings.

Additionally, sulfur containing food and beverage recipes can be particularly troublesome with metal containers, metal closures, and/or the coatings for such containers or closures. Sulfur dioxide, sulfite ions, and/or hydrogen sulfide may result from sulfur or protein containing foods and often permeate through conventional protective coatings applied to such closures or containers to contact the underlying metal. The sulfur dioxide and/or sulfite ions also tend to be corrosive towards metals, especially iron or tin, that is commonly used to form conventional closures. Once in contact with the metal substrate, sulfur compounds can react with various species present on the metal surface and, combined with iron or tin, result in undesirable corrosion (e.g., bubbling, blistering, etc.) and/or unattractive dark spots or patches on the metal substrates of the container or closure. Such shortcomings have been found particularly problematic on the recently developed metal passivation pre-treatments that are hexavalent chromium-free or have not been passivated using a chromium-containing composition.

In other contexts, coating compositions suitable for architectural paints and stains tend to be complex mixtures of ingredients including pigments, resins/binders, solvents, surfactants, extenders, and other functional additives. Such coatings may be applied to a variety of substrates including wood, metals, masonry, or drywall to suggest but a few typical substrates. The compositions for the coatings may vary depending on the application, but one conventional functional additive for such coating compositions is often zinc oxide, which may function as an extender, a corrosion inhibitor, a UV absorber, and/or a stain blocker in the composition. However, a shortcoming of zinc oxide in architectural coating compositions, particularly coating compositions exposed to UV and moisture from external environments, is that any impact of the zinc oxide over time is often degraded. Zinc oxide, in some instances, can be solubilized (even in mildly acidic conditions) leading to the zinc oxide leaching from an applied coating. In such instances, any functional benefit of the zinc oxide including mildew inhibition and/or any synergies with other mildewstats is lessened.

### SUMMARY

In one embodiment, the present disclosure provides a packaging container, or a portion thereof, comprising a metal substrate; and an interior coating applied on at least a portion of the metal substrate, the interior coating formed from a coating composition including one or more film-forming binder resins and one or more inorganic metallic sulfur-species scavenging components.

In other embodiments, the one or more inorganic metallic sulfur-species scavenging components have at least one and preferably both of: (i) a water solubility at a pH of 5 or less (e.g. pH of 5) and at 25° C. of less than about 10 mg/liter, preferably less than about 5 mg/liter, and more preferably less than about 1 mg/liter or (ii) a water solubility at a pH of 5 or less (e.g., pH of 5) and at 25° C. at least 10-fold lower than the water solubility of zinc oxide and, preferably, at least 100-fold lower than the water solubility of zinc oxide.

In other embodiments, the packaging container, or a portion thereof, of the previous paragraphs may include one or more optional features or embodiments in any combination thereof. These optional features or embodiments may include one or more of the following: wherein the inorganic metallic sulfur-species scavenging component includes zinc and, optionally, at least one secondary metal, preferably aluminum, titanium, tin, iron or the like; and/or wherein the inorganic metallic sulfur-species scavenging component is a spinel oxide, preferably of the general structure AB₂O₄ wherein A is a divalent metal ion, preferably zinc, and B is at least one metal having a valence greater than 2, preferably aluminum; and/or wherein the inorganic metallic sulfur-species scavenging component includes a zinc ferrite, a zinc aluminate, a zinc titanate, or a combination thereof, and preferably, includes a zinc aluminate; and/or wherein the inorganic metallic sulfur-species scavenging component has a solubility of no more than 1 mg/L of aluminum ions and/or 5 mg/L of zinc ions in 10 percent acetic acid; and/or wherein the inorganic metallic sulfur-species scavenging component is substantially free of wax, and preferably, is free of any wax coatings; and/or wherein the metal substrate includes a metal substrate that has not been passivated using a hexavalent chromium containing composition, a trivalent chromium containing composition, or any chrome-based compositions; and/or wherein the metal substrate is pretreated with a pretreatment composition comprising a zirconium compound and one or more optional polymers (e.g., polyurea, polyester, acrylic, polyolefin, or combinations thereof); and/or wherein the metal substrate is part of a removable closure (e.g., twist-off closure); and/or wherein the one or more film-forming binder resins include polymers selected from polyester resins, polyether resins, acrylic resins, polyolefin resins, polyvinylchloride resins, derivatives thereof, or mixtures thereof, and/or wherein the coating composition is a powder coating composition or a liquid coating composition (e.g., an aqueous coating composition or an organic solvent-based coating composition); and/or wherein the interior coating is a food-contact interior coating; and/or wherein the inorganic metallic sulfur-species scavenging component has a distribution of particle sizes with the smallest particle in the distribution being greater than 100 nm, preferably at least 150 nm, and more preferably, at least about 200 nm as measured by laser diffraction; and/or wherein the inorganic metallic sulfur-species scavenging component has a D50 distribution of particle sizes of about 2 microns or less, preferably, about 1.8 microns or less, and more preferably, about 1 micron or less as measured by laser diffraction; and/or wherein the inorganic metallic sulfur-species scavenging component has a surface area of at least about 1 m²/g as determined by ASTM D3037, or preferably at least about 1 m²/g to about 50 m²/g, more preferably about 3 m²/g to about 40 m²/g, and even more preferably about 10 m²/g to about 30 m²/g; and/or wherein the inorganic metallic sulfur-species scavenging component have a particle size ranging from a D10 at least about 0.3 microns to a D90 of about 10 microns or less, preferably a D10 of at least about 0.5 microns to a D90 of about 6 microns or less, and more preferably, a D10 of at least about 1 micron to a D90 of about 5 microns or less; and/or wherein the coating composition, based on total nonvolatile weight, has at least about 0.01 weight percent of the inorganic metallic sulfur-species scavenging component, preferably at least about 0.5 weight percent, and more preferably, at least about 1 weight percent; and/or wherein the coating composition, when dried as a coating on the interior surface of the substrate, has about 10 weight percent or less of the inorganic metallic sulfur-species scavenging component, preferably, about 8 weight percent or less, and more preferably, about 5 weight percent or less; and/or wherein the coating composition, based on total nonvolatile weight, includes zinc provided by the inorganic metallic sulfur-species scavenging component; and/or further including a first and a second coating applied to at least a portion of the interior surface of the substrate and wherein the interior coating from the coating composition is either the first coating, the second coating, or both the first and the second coating; and/or wherein one of the first coating, the second coating or both has a concentration of the inorganic sulfur-species scavenging component within a surface region of the respective dried coating greater than a concentration of the inorganic metallic sulfur-species scavenging component within a central region of the respective dried coating; and/or wherein the first coating (e.g., size coat or base coat) includes the inorganic metallic sulfur-species scavenging component; and/or wherein the first coating includes a polyester-based or polyether-based coating, and optionally one or more crosslinkers (e.g., a phenolic crosslinker); and/or wherein the second coating (e.g., top coat) is a PVC organosol including a thermoplastic polyvinyl chloride (PVC) polymer, one or more stabilizers (for the PVC), and one or more crosslinkers (e.g., phenolic crosslinkers), and optionally one or more other binder polymers (e.g., acrylics, polyesters, polyethers, and the like); and/or further including a sealing gasket; and/or wherein the sealing gasket is a polyvinylchloride-containing sealing gasket, a polyolefin-containing sealing gasket, and/or a polyester-containing sealing gasket; and/or wherein the interior coating, when contacted with an aqueous test solution including 4 weight percent acetic acid, 0.5 weight percent sodium chloride, and 0.052 weight percent sodium metabisulfite and heated for 30 minutes at 100° C. and then stored at 35° C. for 7 weeks (while still contacting the aqueous test solution), the aqueous test solution has no more than 5 ppm of zinc from the inorganic sulfur-species scavenging component, wherein zinc concentration may be determined by inductively coupled plasma mass spectrometry (ICP-MS); and/or wherein the interior coating, when contacted with an aqueous test solution including 4 weight percent acetic acid, 0.5 weight percent sodium chloride, and 0.052 weight percent sodium metabisulfite and heated for 30 minutes at 100° C. and then stored at 35° C. for 7 weeks (while still contacting the aqueous test solution) remains free of visible blistering; and/or wherein the interior coating, when contacted with an aqueous test solution including 4 weight percent acetic acid, 0.5 weight percent sodium chloride, and 0.052 weight percent sodium metabisulfite and autoclaved for 30 minutes at 100° C. and then stored at 35° C. for 3 weeks (while still contacting the aqueous test solution) has a corrosion rating of 4 or less as defined herein; and/or wherein the interior coating, after baking has a delta E color change of about 10 or less, about 5 or less, or about 1 or less; and/or wherein the coating composition, based on total nonvolatile weight, includes about 10 to about 20 weight percent polyester resin, about 0 to about 25 weight percent phenolic resin, about 0 to about 5 weight percent urea-formaldehyde resin, and about 0 to about 50 weight percent polyvinylchloride; and/or wherein the coating composition, based on total resin weight, includes about 10 to about 70 weight percent polyester resin, at least about 5 weight percent of crosslinker (and preferably about 5 to about 40 weight percent of crosslinker); and/or wherein the coating composition includes about 0.1 to about 20 weight percent of the inorganic sulfur-species scavenging component, preferably about 0.1 to about 10 weight percent, more preferably about 0.1 to about 5 weight percent, and most preferably about 0.1 to about 2 weight percent; and/or wherein the coating composition includes about 30 to about 50 weight percent of total solids; and/or wherein the coating composition is substantially free of each of bisphenol A, bisphenol F, or bisphenol S, or any epoxides thereof, and wherein the coating composition is optionally substantially free of styrene; or wherein the coating composition does not contain any bisphenol A, bisphenol F, bisphenol S, epoxides thereof, or styrene or structural units derived from bisphenol A, bisphenol F, bisphenol S, epoxides thereof, or styrene; and/or wherein the packaging container or portion thereof, comprises a food or beverage can, or a food or beverage can end, or both.

In another embodiment, the present disclosure includes a coating composition including any embodiment as described in the previous paragraphs. In further embodiments, the coating composition is a liquid coating composition; and/or the liquid coating composition includes about 30 to about 50 weight percent of total solids; and/or the liquid coating composition is an aqueous coating composition or an organic solvent-based coating composition; and/or wherein the organic solvent is selected from aliphatic hydrocarbons, aromatic hydrocarbons (e.g., toluene, xylene and blends thereof), alcohols, (e.g., isopropyl alcohol, n-butyl alcohol, and ethyl alcohol and blends thereof), ketones (e.g., cyclohexanone, ethyl aryl ketones, methyl aryl ketones, and methyl isoamyl ketone and blends thereof), esters (e.g., alkyl acetates, ethyl acetate and butyl acetate and blends thereof), glycol ethers (e.g., ethylene glycol monomethyl ether, ethylene glycol monoethyl ether, ethylene glycol monobutyl ether, and propylene glycol monomethyl ether and blends thereof), glycol ether esters (e.g., propylene glycol monomethyl ether acetate and the like), aprotic solvents (e.g., tetrahydrofuran and the like), mixtures of these solvents, and the like; and/or wherein the coating composition is a powder coating composition.

In other embodiments, a method of causing and/or using an inorganic metallic sulfur-species scavenging components in a packaging container or portion thereof for scavenging sulfur-species, wherein the one or more inorganic metallic sulfur-species scavenging components is described in any embodiment of this Summary. In other embodiments, the method of causing and/or using includes the one or more inorganic metallic sulfur-species scavenging compositions as have at least one and preferably both of: (i) a water solubility at a pH of 5 or less (e.g. pH of 5) and at 25° C. of less than about 10 mg/liter, preferably less than about 5 mg/liter, and more preferably less than about 1 mg/liter or (ii) a water solubility at a pH of 5 or less (e.g., pH of 5) and at 25° C. at least 10-fold lower than the water solubility of zinc oxide and, preferably, at least 100-fold lower than the water solubility of zinc oxide.

In other embodiments, the present disclosure also relates to a coating composition of as described by any of the embodiments of this Summary.

### Glossary of Terms

Unless otherwise specified, the following terms as used herein have the meanings provided below.

The term “substantially free” when used with respect to a coating composition that may contain a particular compound means that the coating composition contains less than 1,000 parts per million (ppm) of the recited compound (corresponding to less than 0.1 wt. %) regardless of the context of the compound (e.g., whether the compound is mobile in the coating or bound to a constituent of the coating—e.g., as a structural unit of a polymer or other material). The term “essentially free” when used with respect to a coating composition that may contain a particular compound means that the coating composition contains less than 100 parts per million (ppm) of the recited compound regardless of the context of the compound. The term “essentially completely free” when used with respect to a coating composition that may contain a particular compound means that the coating composition contains less than 5 parts per million (ppm) of the recited compound regardless of the context of the compound. The term “completely free” when used with respect to a coating composition that may contain a particular compound means that the coating composition contains less than 20 parts per billion (ppb) of the recited compound regardless of the context of the compound. When the phrases “free of” (outside the context of the aforementioned phrases), “do not contain”, “does not contain”, “does not include any” and the like are used herein, such phrases are not intended to preclude the presence of trace amounts of the pertinent structure or compound which may be present but were not intentionally used, e.g., due to the presence of environmental contaminants. As will be appreciated by persons having ordinary skill in the art, the amount of a compound in an ingredient, polymer, formulation or other component typically may be calculated based on the amounts of starting materials employed and yields obtained when making such ingredient, polymer, formulation or other component.

The term “sealing composition” refers to a material applied to a coating system on an interior surface of a closure (such as, twist off lids or caps) for purposes of helping to seal the closure to a container. In some embodiments, a sealing composition also is referred to as a gasket compound or a gasketing compound or a sealing compound because the sealing composition is used to form a gasket on the coating system. In a typical mode of practice, the sealing composition is applied as a fluid composition or hot melt onto the coating system to form a gasket precursor. The precursor is then dried, crosslinked, and/or otherwise chemically and/or physically cured to form a gasket.

The term “organosol” refers to a dispersion of organic particles comprising one or more thermoplastic resins (e.g., thermoplastic particles such as PVC particles) optionally in combination with one or more other ingredients or reaction products thereof, in a liquid carrier that includes an organic solvent, and is typically an organic-solvent based liquid carrier (as opposed to a water-based liquid carrier). In addition to solvent, the liquid carrier may incorporate one or more other optional ingredients, e.g., at least one plasticizer, surfactant, etc.

The term “resin” means an oligomer and/or polymer. Oligomers or polymers may include polymerizable functionality that allows the resin to be further polymerized, cross-linked, or otherwise reactive as desired. The term “oligomer” means a compound incorporating from two to ten repeating units. The term “polymer” means a compound incorporating 11 or more repeating units. Repeating units typically are derived from one or more monomers. A “monomer” generally includes at least one polymerizable moiety and generally constitutes a single repeating block when incorporated into an oligomer or polymer. A monomer may be incorporated into oligomers or polymers via co-polymerization with itself or with one or more other kinds of monomers, oligomers, and/or polymers. Non-polymerizable terminal moieties, e.g., a monoalcohol or alkoxy group with no additional reactive functional group, are not considered repeating units for purposes of the present invention. Polymers often have number average molecular weights in the range from about 1,000 to 1,000,000 (or more) or even from about 2,000 to about 250,000, or even from about 2,000 to about 50,000, or even 3,000 to 25,000.

The term “polymer” includes both homopolymers (repeating units are derived from the same monomer) and copolymers (i.e., polymers of two or more different monomers). Similarly, “oligomer” includes both homo-oligomers and co-oligomers.

The term “crosslinker” refers to a molecule capable of forming a covalent linkage between two or more resins or between two or more different regions of the same resin. Some embodiments of crosslinkers may be resins. A resin may be a crosslinker for one or more other resins or resin precursors. A resin may be a crosslinker that is self-crosslinking.

The terms “comprises”, “having”, “including”, “incorporating”, and variations thereof do not have a limiting meaning where these terms appear in the description and claims but rather are intended to be open-ended.

The terms “preferred” and “preferably” refer to embodiments of the invention that may afford certain benefits in some modes of practice. However, other embodiments may also be preferred or otherwise suitable, under the same or other circumstances. Furthermore, the recitation of one or more preferred embodiments does not imply that other embodiments are not useful, and such recitation is not intended to exclude other embodiments from the scope of the invention.

As used herein, “a,” “an,” “the,” “at least one,” and “one or more” are used interchangeably. Thus, for example, a coating composition that comprises “an” amine can be interpreted to mean that the coating composition includes “one or more” amines.

Also herein, the recitations of numerical ranges by endpoints include all numbers subsumed within that range (e.g., 1 to 5 includes 1, 1.5, 2, 2.75, 3, 3.80, 4, 5, etc. and at least 1 includes 1, 1.03, 1.5, 2, 17, etc.).

### DETAILED DESCRIPTION

The details of one or more embodiments of the present disclosure are set forth in the description below and the summary above. Other features, objects, and advantages will also be apparent from the summary above and the description and the claims that follow. The following description is not intended to describe every implementation of the novel discoveries herein. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list. The disclosure herein will first generally describe the container, closure, and coating systems thereof and, then more specifically describes various aspects of the container, closure, and coating systems.

In general, the present disclosure provides a packaging container, or a portion thereof (e.g., a removable closure for a packaging article or container), one or more coatings and/or a coating system including such coatings applied on at least a portion of an interior surface of a substrate (e.g., a metal substrate) forming the container or closure, coating compositions useful to form the coatings or coating systems for the container or closures herein, the resultant coating systems, and/or associated methods of making such closures, coatings, systems, and packaging articles or closures thereof. The coating compositions herein are preferably applied directly (i.e., the coating composition directly contacts the substrate) or indirectly (i.e., there is one or more intervening layers between at least a portion of the coating composition and at least a portion of the substrate) to the desired metal substrate to form a coating at least proximal to the substrate. Advantages of the resultant coatings and coating systems herein is that, among other features, they show excellent adhesion to both a metal substrate and to gasket material, show excellent chemical resistance to items such as acidic food and beverage materials as well as sulfur-containing and/or sulfur-releasing food or beverage materials, and/or show excellent corrosion and/or stain resistance in such contexts.

In one approach, the coating compositions for the coating systems herein generally include ingredients comprising one or more film-forming binder resins and one or more inorganic sulfur-species scavenging components, and more preferably, one or more inorganic metal-containing or metallic sulfur-species scavenging components. In one embodiment, the one or more metal-containing inorganic sulfur-species scavenging components have a water solubility at a pH of 5 or less (preferably, pH of 5) and at 25° C. of less than about 10 mg/liter, preferably less than about 5 mg/liter, and more preferably less than about 1 mg/liter. In another embodiment, the one or more metal-containing inorganic sulfur-species scavenging components have a water solubility at pH of 5 and at 25° C. lower than the solubility in water of zinc oxide as discussed more below and, in some embodiments, a water solubility at a pH of 5 or less (e.g., pH of 5) and at 25° C. at least 10-fold lower than the water solubility of zinc oxide and, preferably, at least 100-fold lower than the water solubility of zinc oxide.

In other approaches or embodiments, the inorganic metallic sulfur-species scavenging component includes zinc with at least one other secondary metal such as aluminum, titanium, iron, and the like. In some approaches, the inorganic metallic sulfur-species scavenging component is a spinel oxide, preferably of the general structure AB₂O₄ wherein A is a divalent metal ion, preferably zinc, and B is at least one metal ion having a valence of 2 or greater, preferably aluminum. As discussed more below, such structure does not reflect molar amounts of the various components, but rather reflects a basic structural configuration of the cations and anions. In such embodiment, the inorganic metallic sulfur-species scavenging component includes a zinc ferrite, a zinc aluminate, a zinc titanate, or a combination thereof, and preferably, includes a zinc aluminate.

The coating compositions herein may be a powder coating composition or a liquid coating composition (such as an aqueous coating composition or an organic solvent-based coating composition). In approaches, the coating compositions may preferably include no more than a de minimus amount of water, such as less than about 2 wt-%, less than about 0.5 wt-%, or less than about 0.1 wt-%, if any water.

As discussed more below and in one embodiment, the one or more inorganic sulfur-species scavenging components of the coating compositions herein provide a particulate matter in the dried coating that protect the closures or containers herein from corrosion due to at least sulfur or sulfur dioxide containing species. In other embodiments, the one or more inorganic components including zinc aluminate may provide a particulate matter that function as a mildewstate or mildewcide in architectural coatings. As such, in preferred embodiments, the inorganic components and particles herein remain as discrete particles within the formed coating layer(s) after all coating, drying, and/or baking steps are completed. In approaches, the inorganic sulfur-species scavenging component herein may be any suitable inorganic material capable of reacting with or entrapping sulfur dioxide or derivatives thereof, such as sulfite ions, and may, in some approaches, be selected from a zinc aluminate, a zinc titanate, zinc chromate, other mixed oxides or combinations thereof, and preferably, is an uncoated zinc aluminate as discussed more below.

In yet other approaches, the binder resins for the coating compositions herein are not particularly limited and the one or more film-forming binder resins may include one or more film-forming polymers or copolymers selected from, but not limited to, epoxies (or polyethers), polyesters, polyolefins, halogenated polyolefins such as polyvinyl chloride (“PVC”) particles and/or PVC solutions vinyls, phenolics, alkyds, oleoresins, acrylics, and the like resins and binders.

The metal used to form the substrates of the closures and/or containers herein could be subjected to one or more pre-treatment steps by the manufacturer of the metal sheet used to form the substrate. In some instances, there are chemical pretreatments such as one or more pretreatment composition applied to the metal via, for example, spraying or dipping. For example, in some instances, the metal substrate is pretreated with a pretreatment composition comprising a zirconium compound and one or more polymers selected from polyester, acrylic, polyolefin, or combinations thereof. These pre-treatments may deposit one or more, often relatively thin layers on the metal substrate (e.g., less than 1 micron in thickness). Such layers may be organic, inorganic, or combinations of these. Such pre-treatment layers are considered to be part of the metal substrate. In some instances, the metal used to form the substrates herein are hexavalent chromium-free or so-called CFPA substrates (chromium-free-passivation alternative or electrolytic zirconium passivation (EZT) or trivalent chromium-coating technology (TCCT)) that include metal substrates substantially free, essentially free, or completely free of any pretreatments including hexavalent chromium or trivalent chromium (see, e.g., US 2022/0154360 A1 and patent references described therein, which are all incorporated herein by reference). CFPA metal substrates herein may be defined by DIN EN10202. Suitable pretreatments may be described in CA 2,166,331; U.S. Pat. No. 5,427,632; or WO 9504169, which are all incorporated herein by reference. In yet other approaches, the metals used herein to form the substrates may be chrome-free substrates.

The containers, portions thereof, or closures herein generally have an interior and an exterior surface, and the coating compositions of the present disclosure are useful, in various embodiments, as monocoat or multilayer coating systems applied on the interior surfaces. In illustrative modes of practice, the features of the coating compositions described herein (that is at least the binder resins and sulfur-species scavenging particles) can be used within a first or base layer/coating applied directly to the metal substrate (e.g., a metal substrate that has been subjected to one or more pretreatments such as those discussed in the preceding paragraph). This first base coating also may be referred to as a size coating or a primer coating. In other instances, the coating compositions herein may also include ingredients (that is at least the binder resins and sulfur-species scavenging particles particles) useful within a second coating applied directly or indirectly to the first coating to form a second coating layer from the substrate. The second coating may be referred to as a topcoat, top coat, or top coating even though one or more additional, but optional coatings and/or other materials, such as a sealing composition, may be further applied to at least a portion of the second coating. Although the coating systems may optionally include additional layers, some preferred embodiments of a multilayer coating system comprise and/or consist essentially of the first coating and the second coating optionally used in combination with a sealing or gasket compound described more below. In other illustrative modes of practice, the ingredients forming the coating compositions herein (that is binder resins and composition particles) can be used as a coating forming the base layer, the top coating, or both.

In some particular embodiments, the one or more inorganic sulfur-species scavenging components are included in one or more layers of a multi-layer coating system. Examples of such multi-layer system include interior closure coating systems or food-easy-open can end interior coating systems such as those described, for example, in U.S. Pat. Nos. 8,142,858, 8,574,672, 10,516,502, 11,117,164, U.S. Publ. No. 2016/0221733, and U.S. Publ. No. 2017/0137665. In such systems, typically the base layer (often referred to as a “size” or “primer” coat or first layer herein) is a polyester-based or polyether-based coating, and typically including one or more crosslinkers such as a phenolic crosslinker. The top-coat layer is often a PVC organosol that typically includes a thermoplastic polyvinyl chloride (PVC) polymer, one or more stabilizers (for the PVC), and one or more crosslinkers (e.g., phenolic crosslinkers), and optionally one or more other binder polymers (e.g., acrylics, polyesters, two-coat systems without PVC, and the like).

In some embodiments, the one or more inorganic-sulfur species scavenging components are included in a mono-layer closure coating system. An example of such a closure coating system is described in U.S. Pat. No. 10,486,865, which described embodiments that substantially free of polyvinyl chloride. An example of a mono-layer PVC organosol is described in U.S. Pat. No. 7,682,674.

In many embodiments, a sealing composition may be applied to at least a portion of the coating system in a manner effective to form a gasket that enhances the seal between the closure and a container (e.g., a glass jar). In some embodiments, the sealing composition is provided in the form of an annular gasket adhered directly or indirectly to the coating system or the container in a manner such that the gasket sealingly engages the container or closure (as the case may be), such as engaging a rim (e.g., a rim of a glass jar), when the closure is fit onto the container.

The coating compositions disclosed herein may be used on many types of packages or containers and contact many different types of packaged products. Examples of food or beverage products often packaged in such packages or containers (e.g., glass containers with metal closures) may include certain acid-based food or beverages, milk-based products, meat-based products, onions, sauerkraut, fish in sauce, marinades, mussels, fruits in sweet sauces, energy drinks, coffee drinks, soups, mustard, mayonnaise, ketchup, salad dressings, pickled vegetables, sauerkraut, cooking sauces, and the like. The coating compositions disclosed herein may be used to coat interior surfaces of containers or container parts (e.g., closures) for contacting such food or beverage products, including coatings suitable for long-term contact with products having challenging sulfur-containing species associated therewith. The coating compositions disclosed herein may also be used to protect interior surfaces of packaging for non-food products, such as but not limited to, hair spray, hair dye, paints and stains, joint compound, concrete mixes, glue, cleaning compositions, etching compositions, pharmaceuticals, nutraceuticals, fertilizers, and the like. Exemplary packaging on which the coating compositions disclosed herein may be used (e.g., as an interior coating) include, but are not limited to, cans such as beverage cans, drums, kegs, pails, decorative tins, tubes, bottles, jars, monoblocs, closures, and the like. Exemplary closure devices include, but are not limited to, caps, lids such as thin aluminum foil based lids for yogurt and butter containers, or crown corks; closures for glass jars and bottles such as roll-on closures, vacuum closures, twist on/offlids, pilfer-proof closures, easy peel lids, and easy open end or conventional ends for cans. Cans on which the closures of the invention can be used include, for example, 2-piece cans or 3-piece cans or glass jars. Beverage cans include, but are not limited to, beer cans, carbonated soft drink cans, energy drink cans, isotonic drink cans, water cans, juice cans, tea cans, coffee cans, milk cans, and the like. Food cans, include, but are not limited to, vegetable cans, fruit cans, meat cans, soup cans, ready meal cans, fish cans, edible oil cans, sauce cans and the like. The coating compositions herein may be used on any part of the packaging container surfaces and for example, may be applied to surfaces other than closures such as the coating the insides of certain food and beverage cans that do not have a closure.

The coated packaging containers (e.g., food or beverage cans) or portions thereof (e.g., closures) of the invention may be formed via any suitable method. The coating compositions of the present invention may, for example, be applied to and at least partially cured on a substrate material, such as a metal sheet, coil, foil or the like. Next, the coated substrate may be formed into the final closure shape (or other container part shape) via the desired technique(s). Illustrative embodiments of the coating system are sufficiently flexible to allow shaping after the cured coatings are formed. If the coating is partially cured at the time the closure (or other container part) is shaped, the coating may be more completely cured after shaping.

In preferred embodiments, the cured protective coating system exhibits not only good flexibility, but also excellent chemical resistance, stain resistance, blush resistance, color resistance, and the like especially in the presence of foodstuffs containing sulfur, and/or acetic acid, and/or citric acid and/or lactic acid, and without exhibiting undue loss of adhesion. In the alternative, a substrate may be formed into a closure (or any other packaging article or portion thereof disclosed herein), and then the closure (or other packaging article or portion thereof disclosed herein) may be coated with the coating composition system. The substrate or coated substrate (as the case may be) used in the closure (or other packaging article or portion thereof disclosed herein) may be formed via stamping, drawing, redrawing, wall ironing, bending, beading, embossing, debossing, flanging, necking, stretching, blow-stretching, a combination thereof, or any other suitable conventional method.

In one aspect, the present disclosure provides a rigid metal closure, such as a twist-off metal lid which may include fastening features such as lugs or threads, for use in sealing a food or beverage packaging container. Such packaging or containers often include a glass or plastic jar or bottle configured to receive the threads, lugs, or other engagement structure of the closure. The metal closure preferably includes a coating system of a monocoat or multilayer coating as described herein applied on at least a portion of an interior surface (that is, food-facing or beverage-facing surface) of the metal closure as a food-contact coating. In one embodiment, a first layer composition forms a first coating adhered to the metal substrate and a second layer composition forms a second coating adhered to the first layer composition. As previously discussed, often the surface of the metal substrate (e.g., steel, aluminum, and the like) has been treated with a pretreatment composition (e.g., a chromium-containing or chromium-free pretreatment composition such as any of those disclosed herein) such that pretreatment composition is present on the surface of the metal substrate. (As previously discussed, the pretreatment is considered part of the metal substrate and, thus, its mere presence, in combination with a single applied coating layer, does not yield a multi-layer coating system.) Optionally, sealing composition (which may, e.g., be either a conventional PVC-based sealing compound or a PVC-free sealing compound) may be applied directly to the second composition. In one embodiment, the closure is formed from metal sheet having the coating system cured on at least one side thereof—more typically the interior side (i.e., the surface that is ultimately the food or beverage facing surface).

The metal substrates forming the closures and other containers or portions thereof herein can be formed from a wide range of materials. Such materials include metallic materials, polymeric materials, combinations of these, and the like. In preferred modes of practice, the substrate includes one or more metallic materials such as metals, metal alloys, intermetallic compositions, metal containing composites, combinations of these, and the like. Metallic embodiments of the substrate may comprise one or more metals including, but not limited to, aluminum and aluminum alloys, tinplate, cold rolled low carbon mild steel (“ETP”), electrolytic chromium/chromium oxide coated cold rolled low carbon mild steel (ECCS), tin-free steel, black plate, corten steel, and any other steel.

The substrate may comprise one or more layers. Each layer may have a thickness in the range of from 0.01 μm (micrometer) to 2 mm (millimeter); for example, from 0.01 μm to 1.5 mm; or in the alternative, from 0.01 μm to 1 mm; or in the alternative, from 0.01 μm to 0.5 mm; or in the alternative, from 0.01 μm to 0.2 mm; or in the alternative, from 0.01 μm to 0.1 mm or in the alternative, from 0.01 μm to 100 μm; or in the alternative, from 0.01 μm to 50 μm; or in the alternative, from 1 μm to 50 μm; or in the alternative, from 1 μm to 15 μm, or in the alternative, from 0.12 mm to 0.22 mm.

In addition to the coating system, the substrate optionally may be pre-treated with one or more pre-treatment compositions, which are considered part of the substrates for purposes of the disclosures herein. Such pre-coating compositions optionally may include, but are not limited to, one or more resin binders, one or more resin crosslinkers, one or more solvents, one or more additives, and one or more pigments. Exemplary resin binders include, but are not limited to, epoxy, polyester, polyvinyl chloride containing organosols/vinyls, phenolic, alkyd, oleoresin, acrylic resin, and the like. As mentioned above, the metal substrates, in one embodiment, are chromium-free or CFPA substrates (chromium-free-passivation alternative) that include metal substrates substantially free, essentially free, or completely free of any pretreatments including chromium such as hexavalent chromium or trivalent chromium, and the like. Presently preferred chromium-free pretreatment compositions include zirconium.

The disclosure will now turn to more specifics of the coating composition, container, and/or closure therefor.

### Inorganic Metallic Sulfur-Species Scavenging Component

The inorganic sulfur-species scavenging component preferably include one or more water-insoluble (as defined herein) inorganic materials, and more preferably, water-insoluble inorganic metallic materials capable of scavenging simple sulfurous gasses, such as sulfur dioxide and/or hydrogen sulfide, or water-soluble derivatives thereof including sulfite ions, and thus, function as a corrosion inhibitor. Preferably, the inorganic sulfur-species scavenging component is a metal-containing inorganic sulfur-species scavenging component. The inorganic sulfur-species scavenging components may be any inorganic material having the water solubility discussed herein and effective to scavenge such sulfur compounds that may migrate from a food or beverage. In embodiments, the activity of such inorganic substance hinders, and in some instances, prevents the sulfur from interacting with and/or contacting the metal substrates of the closures or other packaging articles herein. Without wishing to be limited by theory, the scavenging activity of the inorganic substances may be the particular inorganic metal reacting with the sulfur substance and/or crystalline forms of the inorganic substance entrapping or adsorbing the sulfur compounds.

In preferred approaches, the inorganic substance of the sulfur-species scavenging component includes a metal, and more preferably zinc and at least one secondary metal such as aluminum, titanium, iron, or the like. Spinel oxides may be used, preferably of the general structure AB₂O₄ wherein A is a divalent metal ion, preferably the zinc, and B is at least one metal having a valance of 2 or greater or a trivalent metal ion, preferably aluminum. In more preferred approaches, the inorganic sulfur-species scavenging component includes a zinc ferrite, a zinc aluminate, a zinc titanate, or a combination thereof, and most preferably, includes a zinc aluminate. As understood, the structural formula for the spinal oxide noted above does not reflect molar amounts of the anions and cations, but rather the structural configuration of the crystalline arrangement.

The inorganic substance may optionally be doped with various other metals and/or metal oxides in order to direct the effectiveness of interactions with sulfur-containing gases like SO₂ or H₂S. Such doped oxides, for instance a potassium-doped zinc aluminate, may also be used as needed for a particular application. In the context of the inorganic substance being zinc aluminate, for instance, the scavenging activity may be provided via the zinc aluminate reacting with the sulfur or sulfite ion to yield zinc sulfide. Optionally, a microporous structure of the inorganic material, such as a zinc aluminate, may further entrap or absorb the sulfur compounds within the particle spinal oxide structure of the inorganic substance.

In some approaches, the inorganic substance for the sulfur scavenging component is a particulate material with a high surface area, such as small particles and/or particles having a tortuous or porous microstructure. Typically, the inorganic substance for the sulfur scavenging component has a distribution of particle sizes with the smallest particle in the distribution being greater than 100 nm, preferably at least 150 nm, and more preferably, at least about 200 nm as measured by laser diffraction (described further below). In presently preferred approaches, the inorganic sulfur-species scavenging component has a D50 distribution of particle sizes of about 2 microns or less, preferably about 1.8 microns or less, and more preferably about 1 microns or less as measured by laser diffraction. In other approaches, the smallest particle (e.g., a D1 particle size measured by laser diffraction) is larger than 100 nm. The inorganic substance may also have a high surface area of at least about 1 m²/g as determined by ASTM D3037, preferably at least about 3 m²/g, and more preferably at least about 10 m²/g to about 50 m²/g. Although the upper surface area is not restricted, typically the inorganic substance will have a surface are of 50 m²/g or less as determined by ASTM D3037. Thus, in some embodiments, the inorganic substance has a surface of at least about 1 m²/g to about 50 m²/g, preferably at least about 3 m²/g to about 50 m²/g, and more preferably at least about 10 m²/g to about 50 m²/g, as determined by ASTM D3037.

The particle sizes referred to herein may be determined by laser diffraction particle size analysis using a Beckman Coulter LS 230 Laser Diffraction Particle Size Analyzer or equivalent, calibrated as recommended by the manufacturer. Particle size distribution and/or the particle size “D-values” (e.g., D10, . . . . D50, D90, D95, and D99) are the particle sizes which divide a sample's volume into a specified percentage when the particles are arranged on an ascending particle size basis. For example, for particle size distributions the median is called the D50 (or ×50 when following certain ISO guidelines). The D50 is the particle size in microns that splits the distribution with half above and half below this diameter. The Dv50 (or Dv0.5) is the median for a volume distribution. The D90 describes the particle size where ninety percent of the distribution has a smaller particle size and ten percent has a larger particle size. The D95 describes the particle size where ninety five percent of the distribution has a smaller particle size and five percent has a larger particle size. The D99 describes the particle size where ninety nine percent of the distribution has a smaller particle size and one percent has a larger particle size. Unless specified otherwise herein, D50, D90, D95, and D99 refer to Dᵥ50, Dᵥ90, Dᵥ95, and Dᵥ99, respectively. The D-values specified herein may be determined by laser diffraction particle size analysis.

Samples for laser diffraction particle size analysis can be prepared, for example, by diluting the samples in a substantially non-swelling solvent (such as cyclohexanone or 2-butoxyethanol) and shaking them until evenly dispersed. The choice of a suitable solvent will depend upon the particular particles to be tested.

In some embodiments, the inorganic sulfur-species scavenging component is also not soluble in water (preferably not soluble in acidic water), and in this context, the inorganic sulfur-species scavenging component has a water solubility at a pH of 5 or less (e.g., pH of 5) and at 25° C. of less than about 10 mg/liter, preferably less than about 5 mg/liter, and more preferably less than about 1 mg/liter. In other contexts, the inorganic component has a solubility in water (e.g., at pH of 5 at 25° C.) less than the solubility in water of zinc oxide and, in some approaches, has a solubility in water a water solubility at a pH of 5 or less (e.g., pH of 5) and at 25° C. at least 10-fold lower than the water solubility of zinc oxide and, preferably, at least 100-fold lower than the water solubility of zinc oxide. As used herein, the zinc oxide refers to zinc oxide USP-1 powder from Upi-chem. In certain preferred embodiments, the inorganic sulfur-species scavenging component has a thermodynamic solubility of no more than 1 mg/L of aluminum ions and/or 5 mg/L of zinc ions in 10 percent acetic acid. Concentration of zinc and/or aluminum ions can be determined according to Annex IL, Restrictions on plastic materials and articles of COMMISSION REGULATION (EU) 2020/1245 of 2 Sep. 2020. Migration testing is set forth in Annex V, Compliance testing of COMMISSION REGULATION (EU) No October 2011 of 14 Jan. 2011

Unlike certain other sulfur-scavenging species (e.g., zinc oxide), use of a wax or other suitable encapsulation material is not necessary to achieve suitable performance in preferred embodiments. While such materials may optionally be used, in most embodiments, the inorganic sulfur-species scavenging components herein are substantially free of wax or wax coatings, and preferably, free of any wax or wax coatings. As used herein, substantially free of wax coatings means the inorganic sulfur-species scavenging components or particles herein have less than about 10 weight percent wax, less than about 5 weight percent wax, less than about 2 weight percent wax, less than about 1 weight percent wax, less than about 0.5 weight percent wax, less than about 0.1 weight percent wax, or no detectible amounts of wax.

In some approaches, the sulfur-species scavenging particles herein may migrate (at least in part) to a coating interface (that is, a top or bottom surface area or surface region of a coating or coating layer) during the drying, curing or baking process of the coating. Such optional migration allows the particles to accumulate at the interface or surface region, creating interfacial layers or zones of a coating enriched in the spinel oxide particles. This migration may be advantageous in the coatings herein because the enriched layers or zones may provide an enhanced filter for entrapping or reacting with the undesired gaseous species like SO₂ or H₂S. This migration effect may also help reducing the overall amount of particles used and therefore the risk of later migration of any metal ions into the food from the coatings herein. Thus, the cured coatings herein may have an enrichment or a concentration of the sulfur-species scavenging particles at a coating interface or at least within a surface region of a dried coating that is greater than a concentration of the sulfur-species scavenging particles within a central region (e.g., substantially diffused throughout therein) of the respective dried coating. While not intending to be bound by theory, in architectural coating applications, a concentration of the scavenging particles towards the surface of the coating (e.g., interior or exterior latex paint) may be beneficial for purposes of preventing/inhibiting microbial proliferation (e.g., mildew and the like) on the coating surface.

As used herein, a coating interface or surface region of a cured coating generally refers to an area or region that has a relative thickness generally extending perpendicularly from the surface of the cured coating to a depth of less than about 0.5 microns beneath a top surface of a respective coating such as, for example, an average such depth of about 0.2 to about 0.5 microns. The interface or surface region enriched with the sulfur-species scavenging particles may be compared to the central region that has less of the sulfur-species scavenging particles relative to the interface or surface region. As used herein, the central region of any cured composition generally refers to another portion of the coating layer which extends beneath the surface region/interface noted above.

The concentration of sulfur-species scavenging particles in either the surface region/interface relative to the central region of a cured coating can be characterized in a variety of ways including, but not limited to, a particle density such as an average number density of particles (for instance, the average number of particles per unit volume) in the surface region being greater than the average number density in the central region. The concentration of particles in a region of a cured coating can be determined, for instance, by a variety of surface analysis techniques known in the art including Scanning Electron Microscopy (SEM). Preferably, concentration in such context is determined by Scanning Electron Microscopy.

### Coating Compositions:

As noted above, the coating compositions herein include at least one or more film-forming binders or resins. Exemplary resin binders include, but are not limited to, polymers or copolymers selected from epoxy (also often referred to as “polyether” polymers), polyester, halogenated polyolefins such as polyvinyl chlorides, phenolic, alkyd, oleoresin, acrylic, polyolefin, and the like resins and binders, copolymers thereof (e.g., polyester-acrylate copolymers, polyester-urethane copolymers, polyether-acrylate copolymers, and the like), and mixtures thereof. While the amount of binder resin is not particularly limited, the compositions may include, in some approaches, greater than about 10 to 70 weight percent of the binder resin(s), based on total resin weight in the compositions.

Exemplary polyolefin binder resins may include structural or monomer units derived from two or more C2 to C12 alpha olefins and may include other optional structural units and/or other optional binder resins as needed for a particular application. In some such approaches, the polyolefin polymer is derived from ethylene and one or more C3-C12 alpha-olefins and, in one example, includes ethylene structural units (or ethylene monomer moieties) as well as C3 to C12 structural units (or C3 to C12 monomer moieties), and in particular, ethylene and propylene. As used herein, an ethylene structural unit (or monomer moiety) generally refers to a —H₂C—CH₂— unit within a copolymer chain, which is derived from an ethylene molecule or reactant during copolymerization, with a similar definition applying to C3-C12 alpha-olefin structural units (or monomer moieties). As used herein, an olefin may also generally refer to a family of organic compounds that are alkenes with a chemical formula CₓH₂ₓ, where x is the carbon number and having a double bond within its structure.

Exemplary polyester binder resins may be thermoplastic or thermosetting resins that include at least one ester linkage (and more typically a plurality of such linkages) as part of the resin backbone. A polyester resin often is derived from a mixture of reactants containing one or more polyols, preferably including at least dihydroxy and optionally trihydroxy polyols and one or more compounds comprising two or more co-reactive carboxylate functionalities, preferably including at least diacid and optionally triacid functionality. Suitable polyols that can be used to prepare polyesters resins include, but are not limited to ethylene glycol, diethylene glycol, triethylene glycol and higher polyethylene glycols, propylene glycol, dipropylene glycol, tripropylene glycol and higher polypropylene glycols, 1,3-propanediol, 1,4-butanediol and other butanediols, 1,5-pentanediol and other pentane diols, hexanediols, decanediols, and dodecanediols, glycerol, trimethylolpropane, neopentyl glycol, hexylene glycol, trimethylolethane, neopentyl glycol, pentaerythritol, dipentaerythritol, cyclohexanedimethanol, naphthalenediol, and mixtures thereof. In some embodiments, the polyester polymer is an aromatic polyester polymer having a glass transition (Tg), as measured using differential scanning calorimetry (DSC), of at least 50° C., at least 70° C., at least 90° C., or 100° C. or more. In some embodiments, the polyester polymer includes one or more “high Tg” cyclic-group-containing polyols such as tricyclodecanedimethanol, 2,2,4,4-tetramethyl-1,3-cyclobutanediol, or 3,9-bis(1,1-dimethyl-2-hydroxyethyl)-2,4,8,10-tetraoxaspiro[5.5]undecane.

Exemplary acrylic binder resins include acrylic resins, vinyl-acrylic resins, styrene-acrylic resins, and the like resins. Useful acrylic resins are prepared through chain-growth polymerization using one or more ethylenically unsaturated monomers. Examples of suitable ethylenically unsaturated monomers include non-functional monomers such as styrene, halostyrenes, α-methylstyrene, alkyl esters of acrylic acid (e.g., methyl acrylate, ethyl acrylate, butyl acrylate, etc.), alkyl esters of methacrylic acid and/or crotonic acid (e.g., methyl, ethyl, propyl, butyl, pentyl, hexyl, octyl, decyl, dodecyl methacrylates and crotonates), vinyl cyclohexane, vinyl cyclooctane, vinyl cyclohexene, hexanediol diacrylate, dimethyl maleate, dibutyl fumarate and similar diesters, vinyl naphthalene, vinyl toluene, vinyl acetate, vinyl propionate, vinyl cyclooctane, ally methacrylate, 2-ethylhexyl acrylate, and diesters of maleic anhydride; and functional monomers such as acid-functional monomers (e.g., acrylic acid, methacrylic acid, crotonic acid, itaconic acid, maleic anhydride and esters thereof, mesaconic acid, citraconic acid, fumaric acid, and sorbic acid), amide-functional monomers (e.g., acrylamide, methacrylamide, etc.), hydroxy-functional monomers (e.g., hydroxyalkyl acrylate or methacrylate monomers such as hydroxyethyl acrylate (HEA), hydroxyethyl methacrylate (HEMA), hydroxypropyl acrylate (HPA), hydroxypropyl methacrylate (HPMA), etc.); and variations and combinations thereof.

Exemplary polyether or epoxy binder resins include polymers with an epoxy group or formed from a compound containing an epoxy group (e.g., via reaction of a diepoxide with an extender such as, e.g., a dihydric phenol compound). The epoxy resin may be a linear epoxy resin with one or more terminal epoxy groups, although no epoxy groups need be present on the resin. The epoxy compound may be aliphatic or aromatic. Suitable epoxy compounds include aromatic compounds such as, for example, epoxy resins based on the diglycidyl ether of tetramethyl bisphenol F (“TMBPF-DGE”). Examples of suitable BPA-free polyether polymers are disclosed, for example, in U.S. Pat. No. 9,409,219 and International App. Publ. Nos. WO2013119686 and WO2021105970. Alternatively, any suitable difunctional compound (or mixture of compounds) capable of reacting with the oxirane groups may be employed. Examples of such compounds may include diacids such as, e.g., sebacic, adipic, azelaic, and dimer fatty acids (e.g., saturated and/or unsaturated dimer fatty acids, more preferably saturated); amines or diamines such as, e.g., butylamine, ethylenediamine, and hexamethylene diamine; amino acids such as, e.g., alanine, lysine, and aminododecanoic acid; diols (e.g., diphenols such as hydroquinone and tetramethyl bisphenol F); and mixtures and variations thereof.

Exemplary halogenated olefin binder resins may include halogenated polyolefins such as, for example polyvinylchloride. In other approaches, the halogenated polyolefins may include, for example, the oligomers, copolymers and homopolymers of vinyl chloride, vinylidenefluoride and its copolymers and homopolymers, polychloroprene, polychloroisoprene, polychlorobutylene, and combinations thereof.

Exemplary crosslinkers may include resins with two or more phenolic repeating units. In many instances, a phenolic resin is obtained by reacting one or more substituted or unsubstituted phenol reactants with one or more aldehydes. Examples of phenol reactants include phenol itself as well as substituted phenols. Illustrative substituted phenols often may be mono-substituted or di-substituted. If substituted phenols are used, these are preferably mono-substituted so that two sites remain for chain growth. Examples of substituted phenols include one or more of o-cresol, p-phenylphenol, p-tert-butylphenol, p-tert-amylphenol, cyclopentylphenol, p-tertoctyl phenol, bisphenol A (not preferred), resorcinol, hydroquinone, catechol, xylenol, cresylic acid, bisphenol-F (not preferred), combinations of these and the like. Derivatives of these reactants, such as etherified or acid functional derivatives, also may be used. Examples of aldehydes include one or more of formaldehyde, furfural, and for acetaldehyde. Phenolic resins may be either novolacs or resoles. A novolac resin is a phenolic resin in which an excess of phenolic reactant is used relative to aldehyde. A resole resin is a phenolic resin in which an excess of aldehyde is used relative to phenolic reactant. In preferred approaches, the coating compositions herein are formulated in a manner such that corresponding cured coatings are substantially free of, more preferably essentially free of, even more preferably essentially completely free of, are substantially free of each of bisphenol A, bisphenol F, and bisphenol S, including epoxides thereof.

In some embodiments, the coating composition is at least substantially free of bisphenol compounds, including epoxides thereof.

In some embodiments, the coating composition is “PVC-free.” That is, the powder coating composition preferably contains, if any, less than 2% by weight of vinyl chloride materials and other halogenated vinyl materials, more preferably less than 0.5% by weight of vinyl chloride materials and other halogenated vinyl materials, and even more preferably less than 1 ppm of vinyl chloride materials and other halogenated vinyl materials, if any.

As discussed more below in the Examples, a packaging container, or a portion thereof, having an interior surface thereof coated with the coating compositions herein, when dried at 200° C. for 12 minutes to form a dry coating weight of about 8 to about 8.5 grams and contacted with an aqueous test solution including 4 weight percent acetic acid, 0.5 weight percent sodium chloride, and 0.052 weight percent sodium metabisulfite and heated for 30 minutes at 100° C. and then stored at 35° C. for 7 weeks (while still contacting the aqueous test solution), exhibits one or more of the following (and preferably a plurality of, and more preferably all of) (i) the aqueous test solution has no more than 5 ppm of zinc from the inorganic sulfur-species scavenging component (zinc concentration may be determined by ICP-MS (inductively coupled plasma-mass spectrometry)) and may also have less than the corresponding SML for the other metals in the metal oxide; (ii) the coating remains free of visual blistering; (iii) the coating exhibits a corrosion rating of 4 or less as defined herein; and/or (iv) the coating composition remains substantially white in color and/or has little color change (e.g., has a delta E of about 10 or less, about 5 or less, or about 1 or less) after baking conditions in contact with or without a gasket. As discussed herein, any corrosion performance evaluations are conducted on regular chromium passivated tin plate. As discussed previously, concentration of zinc and/or aluminum ions can be determined according to Annex IL, Restrictions on plastic materials and articles of COMMISSION REGULATION (EU) 2020/1245 of 2 Sep. 2020. Migration testing is set forth in Annex V, Compliance testing of COMMISSION REGULATION (EU) No Octber 2011 of 14 Jan. 2011

In some embodiments, the coating compositions herein, based on total nonvolatile weight, may include about 10 to about 25 weight percent polyester resin, about 0 to about 25 weight percent phenolic resin, about 0 to about 5 weight percent urea-formaldehyde resin, and about 0 to about 50 weight percent polyvinylchloride. The coating compositions may also include about 0.1 to about 25 weight percent of the inorganic sulfur-species components, in other approaches, about 0.1 to about 10 weight percent, in yet other approaches, about 0.1 to about 5 weight percent, and in further approaches, about 0.1 to about 2 weight percent of the inorganic sulfur-species scavenging component. The coating compositions herein may include about 30 to about 50 weight percent of total solids. In other embodiments, coating compositions herein may include, based on total resin solids, about 10 to about 70 weight percent polyester resin, and preferably greater than 50 weight percent to 70 weight percent polyester resin and about 5 to about 40 weight percent of crosslinker.

### Optional Ingredients

If desired, the coating compositions may optionally include other additives that help to improve the manufacturability or use of the coating compositions or that help to improve the resultant coatings. Suitable optional additives include, for example, those that improve the processability or manufacturability of the composition, enhance composition aesthetics, or improve a particular functional property or characteristic of the coating composition or the cured composition resulting therefrom, such as adhesion to a substrate or adjacent composition. Additives that may be included are carriers, additional polymers, emulsifiers, pigments, metal powders or pastes, fillers, anti-migration aids, anti-microbials, extenders, curing agents, lubricants, coalescents, wetting agents, plasticizers, crosslinking agents, antifoaming agents, colorants, pigments, waxes (not associated with any metal oxide or inorganic particle herein), anti-oxidants, anticorrosion agents, flow control agents, thixotropic agents, dispersants, adhesion promoters, PVC stabilizers, scavenger agents or combinations thereof. Each optional ingredient can be included in a sufficient amount to serve its intended purpose, but preferably not in such an amount to adversely affect a coating composition or a cured coating resulting therefrom.

Exemplary crosslinkers used in a coating composition of the present disclosure include, but are not limited to, phenol-formaldehyde resins; amino-formaldehyde (also referred to as “aminoplasts”) resins including but not limited to urea-formaldehyde, melamine formaldehyde, benzoguanamine formaldehyde; anhydride resins, phenol-formaldehyde crosslinkers (e.g., phenoplasts), amino crosslinkers (e.g., aminoplasts), materials with blocked isocyanate functionality, materials with epoxy functionality including but not limited to (meth)acrylic resins or vinyl resins, carboxyl-reactive crosslinkers (e.g., p-hydroxyalkyl-amide crosslinkers such as the PRIMID XL-552 and PRIMID QM-1260 products from EMS-Griltech) or the like.

Blocked isocyanate crosslinking agents are suitable in many embodiments. A blocked isocyanate is a material including blocked isocyanate functionality that is unmasked upon heating to enable isocyanate crosslinking reactions. While the isocyanate functionality is blocked, the materials typically are stable and substantially non-reactive. If an NCO-functional material is provided in unblocked form, it is possible that the unblocked material may participate in crosslinking reactions sooner than might be desired, e.g., while a formulation is in storage for future use. The temperature at which the blocking is released can vary depending upon the type of blocked isocyanate being used. In many instances, blocking is released at temperatures in the range of 120° C. to 250° C., which conveniently is a suitable temperature range for carrying out crosslinking reactions in many modes of practice. Upon release of the blocking, the resulting polyisocyanates can react with other co-reactive functionality on resins to be crosslinked, such as carboxylate, hydroxyl or amine (primary or secondary) functionality to form amide, urethane or urea linkages.

Suitable embodiments of blocked isocyanates are compounds comprising cyclohexyl moieties such as a blocked isophorone diisocynate (IPDI). Linear, aliphatic blocked isocyanates also would be suitable in many modes of practice. One example of a linear, aliphatic blocked isocyanate is a blocked hexamethylene diisocyanate (HMDI). Aliphatic materials are preferred to avoid the generation of aromatic amines by hydrolysis. Blocked isocyanates in many instances are not pure dimers but are oligomers (isocyanurate, biuret, or similar structures) based on the dimer to help reduce vapor pressure.

Aminoplast crosslinkers are typically the condensation products of aldehydes such as formaldehyde, acetaldehyde, crotonaldehyde, and benzaldehyde with amino or amido group-containing substances such as urea, melamine, and benzoguanamine. Examples of suitable aminoplast crosslinking resins include benzoguanamine-formaldehyde resins, melamine-formaldehyde resins, esterified melamine-formaldehyde, and urea-formaldehyde resins. One specific example of a suitable aminoplast crosslinker is the fully alkylated melamine-formaldehyde resin commercially available from Cytec Industries, Inc. under the trade name of CYMEL 303.

One optional ingredient is a catalyst to increase the rate of crosslinking of the phenolic and/or other crosslinking resins. If used, a catalyst is preferably present in an amount of at least 0.05%, and more preferably at least 0.1%, by weight of nonvolatile material. If used, a catalyst is preferably present in an amount of at most 1%, and more preferably at most 0.5%, by weight of nonvolatile material.

Examples of catalysts, include, but are not limited to, strong acids (e.g., dodecylbenzene sulphonic acid (DDBSA, available as CYCAT 600), methane sulfonic acid (MSA), p-toluene sulfonic acid (PTSA), dinonylnaphthalene disulfonic acid (DNNDSA), and triflic acid), quaternary ammonium compounds, phosphorous compounds, zinc compounds, titanium catalysts, like a tetraalkyl ammonium halide, a tetraalkyl or tetraaryl phosphonium iodide or acetate, tin octoate, zinc octoate, triphenylphosphine, and similar catalysts known to persons skilled in the art.

Another useful optional ingredient is a lubricant, like a wax, which facilitates manufacture of metal closures or other fabricated (e.g., stamped) container parts by imparting lubricity to sheets of coated metal substrate. Waxes also may provide coatings with scratch resistance. A lubricant is preferably present in the coating composition in an amount of 0 to 4%, and preferably 0.1 to 2%, by weight of nonvolatile material. Examples of lubricants include carnauba wax, synthetic wax (e.g., Fischer-Tropsch wax), polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like).

The coating compositions may incorporate one or more pigments. Examples include aluminum flake, and titanium dioxide, and combinations of these. If pigments are used, the resulting coating composition often may have a pigment-to-resin ratio of about 1:50 to 1:2, preferably 1:20 to 1:6, more preferably 1:15 to 1:6. The coating compositions may also include filers such as calcium carbonate or silica.

To effectuate good sealing, the removable closure of the disclosure also typically includes a gasket formed from a suitable sealing composition. The sealing composition is a material that is applied to at least a portion of the top or exposed surface of the coating for the purpose of assisting in sealing the closure to a container. Often the sealing composition is applied in an annular pattern to engage the top rim of a container when the closure is sealed thereon. Structurally, a preferred closure using a sealing composition on a closure of this disclosure would comprise a substrate, the coating systems formed from a coating composition of the present disclosure, and a gasket directly or indirectly on the coatings of the coating system.

Generally, sealing compositions are well known in the industry and any may be used. Some are solid components as applied. Others are fluids that chemically or physically cure to form solid gasketing material. As an example, a sealing composition may comprise at least about 10, more preferably at least about 25, and even more preferably at least about 30 wt-% of thermoplastic material, based on the total nonvolatile weight of the of the sealing composition. For non-solid sealing compositions, the sealing composition preferably includes less than about 60, more preferably less than about 55, and even more preferably less than about 50 weight percent (“wt-%”) of thermoplastic material, based on the total nonvolatile weight of the compound. As previously discussed herein, halogenated polyolefins such as PVC are commonly used thermoplastic materials in closure sealing compositions. In some instances, these polyolefins or other thermoplastic materials have high molecular weight, e.g., number average molecular weights over 20,000, even over 50,000. Other suitable thermoplastic materials may include polyesters and non-halogenated polyolefins (e.g., U.S. Pat. No. 9,662,813 and/or CA 2 091 875). While not intending to be bound by any theory, in some embodiments, the incorporation of a suitable amount of thermoplastic material into the closure compound is believed to be important in achieving good compatibility and adhesion between a sealing composition and the coated closure.

Examples of useful sealing composition include, for example, PVC-containing sealing compositions (including, e.g., plastisols) for sealing closures to food or beverage containers. In some embodiments, the sealing composition may contain a polypropylene additive. Preferred sealing compositions are at least substantially free of each of bisphenol A, F, and S, including diepoxides thereof.

The total film thickness of the cured coating systems of the present invention may vary depending upon a variety of factors, including, for example, the desired properties (e.g., mechanical properties, aesthetic properties, corrosion resistance, etc.) of the cured coating system, the substrate upon which the coating system is applied, the presence of substances that may contact the cured coating system (e.g., certain aggressive or corrosive products), and/or the intended use of the coated article. In presently preferred embodiments, the total dry film weight of a coating in the coating systems herein is at least about 0.2, more preferably at least about 2, and even more preferably at least about 5 g/m² (grams per square meter or gsm). Preferably, the total dry film weight of a cured coating (not including any sealing composition that may be present) is less than about 30 g/m², more preferably less than about 25 g/m², and even more preferably less than about 20 g/m².

Preferably, the coating composition of the present disclosure comprises a liquid carrier. Although aqueous carrier liquids can be used in certain embodiments, the carrier liquid is typically at least substantially non-aqueous). While not preferred, in some embodiments a relatively low amount of water may be included so long as the coating composition is not unsuitably affected. In illustrative embodiments, the liquid carrier includes less than 2 weight percent water, if any, based on the total weight of the liquid carrier.

Examples of suitable liquid carriers include an organic solvent, a plasticizer, or mixtures thereof. Suitable organic solvents include, for example, aliphatic hydrocarbons, like mineral spirits, and high flash VM&P naphtha; aromatic hydrocarbons, like toluene, xylene and blends thereof (e.g., the Aromatic Solvent 100 product); alcohols, like isopropyl alcohol, n-butyl alcohol, and ethyl alcohol; ketones, like cyclohexanone, ethyl aryl ketones, methyl aryl ketones, and methyl isoamyl ketone; esters, like alkyl acetates (e.g. ethyl acetate and butyl acetate); glycol ethers like ethylene glycol monomethyl ether, ethylene glycol monoethyl ether, ethylene glycol monobutyl ether, and propylene glycol monomethyl ether; glycol ether esters, like propylene glycol monomethyl ether acetate; aprotic solvents, like tetrahydrofuran; mixtures of these solvents and the like. Preferred liquid carriers have sufficient volatility to evaporate substantially from the coating system during the curing process.

Examples of suitable plasticizers include phosphates, adipates, sebacates, epoxidized oils (not preferred, but may be used in certain embodiments if desired), polyesters, and combinations thereof.

Coating compositions for use in the present coating system can be prepared using any suitable method to preferably provide sufficient suspension and dispersion of the components included therein. Examples of suitable process methods include solution blending, high-speed dispersion, high-speed milling, and the like. A substantially homogeneous dispersion of the components throughout a liquid carrier typically indicates an adequate mixture or blend.

Preferably, the cured systems are retortable when used in food and beverage container applications. Preferred cured coatings of the present disclosure can withstand elevated temperature conditions frequently associated with retort processes or other food or beverage preservation or sterilization processes. As discussed above, particularly preferred cured coating systems exhibit enhanced resistance to such conditions while in contact with food or beverage products that exhibit one or more aggressive (or corrosive) chemical properties under such conditions and/or sulfur containing food or beverage products.

The coating system of the present disclosure can be applied to a substrate using any suitable procedure such as, for example, spray coating, roll coating, coil coating, curtain coating, immersion coating, meniscus coating, kiss coating, blade coating, knife coating, dip coating, slot coating, slide coating, and the like, as well as other types of pre-metered coating. In one embodiment where the coating is used to coat metal sheets or coils, the coating can be applied by roll coating.

The coating system can be applied to a substrate prior to, or after, forming the substrate into a closure, and typically applied before so that the coated substrate can be formed into a closure. Preferably, at least a portion of the substrate is coated with the coating system of the present disclosure, which is then at least partially cured before the substrate is formed into an article or closure. In one presently preferred embodiment, the following method is used: (1) the coating composition is applied to at least a portion of the substrate, (2) the coating composition is at least partially cured, (3) the coated substrate is shaped to form a closure (e.g., via stamping), (4) the coating is more completely cured if applicable; and (5) a sealing composition is then applied to the cured coating to help provide a gasket for sealing the closure to its corresponding container. Optionally, the further curing of step (4) can be practiced concurrently with and/or after step (5)

Coating systems of the present disclosure are preferably cured to form a hardened coating system. After applying the coating system onto a substrate, the coating compositions of the present disclosure can be cured using a variety of processes, including, for example, oven baking by either conventional or convectional methods, or any other method that provides an elevated temperature. The curing process may be performed in either discrete or combined steps. For example, substrates can be dried at ambient temperature to leave the coating compositions in a largely un-crosslinked state. The coated substrates can then be heated to more fully cure the compositions. In certain instances, coating compositions can be dried and cured in one step.

The curing process for any individual layer or coating of the closures or other substrates may be performed at temperatures in the range of about 150° C. to about 240° C. for about 5 seconds to 1 hour, more typically about 2 minutes to about 30 minutes, and more typically about 3 minutes to about 10 minutes, taking into account, however that the upper end of the temperature range can change depending on the decomposition temperature(s) of the coating constituents (and preferably at the lower end of the rates).

The coating compositions may be used in mono-coat or multilayer systems, such as a two-coat system having a base coat and a top coat. If a multilayer system, the binders and inorganic sulfur-species scavenging components herein may be provided in any of the layers of the system or all of the layers of the system. In approaches, any layer of a mono-coat and/or multi-layer system herein (i.e., the first, second, or both layers), when dried, may include, up to about 10 weight percent of the inorganic sulfur-species scavenging components, up to about 8 weight percent of the inorganic sulfur-species scavenging components, up to about 6 weight percent, or even up to about 4 weight percent of the inorganic sulfur-species scavenging components and preferably, about 0.01 to about 10 weight percent of the inorganic sulfur-species scavenging components or other ranges within the above noted amounts, and more preferably, about 0.1 to about 5 weight percent as measured on a non-volatile portion of the coating composition of the layer. In other approaches, when the inorganic material is a zinc-continuing spinel oxide as discussed above, any layer of the mono-coat and/or the multi-layer system herein (i.e., the first, second, or both layers), when dried, may include zinc provided by the zinc-containing spinel oxide. As noted, the zinc may be enriched at the interface and/or surface regions of any coating layer.

As already discussed above, the inorganic metallic sulfur-species scavenging components may be included in one or more layers of a multi-layer coating system. Examples of such multi-layer systems include interior closure coating systems or food-easy-open can end interior coating systems such as those described, for example, in U.S. Pat. Nos. 8,142,858, 8,574,672, 10,516,502, U.S. Publ. No. 2016/0221733, and U.S. Publ. No. 2017/0137665. In such systems, typically the base layer (often referred to as a “size” or “primer” coat) is a polyester-based or polyether-based coating, and typically including one or more crosslinkers disclosed herein such as a phenolic crosslinker. The top-coat layer is often a PVC organosol that typically includes a thermoplastic polyvinyl chloride (PVC) polymer, one or more stabilizers (for the PVC such as, e.g., an oxirane-functional acrylic resin), and one or more crosslinkers (e.g., phenolic crosslinkers), and optionally one or more other binder polymers (e.g., acrylics, polyesters, and the like). In some embodiments, the inorganic sulfur-species scavenging components are included in a mono-layer closure coating system. An example of such a closure coating system is described in U.S. Pat. No. 10,486,865, which describes embodiments that are substantially free of polyvinyl chloride. An example of a mono-layer PVC organosol is described in U.S. Pat. No. 7,682,674.

### Architectural Coating

The zinc aluminate or other inorganic spinel oxides species discussed herein may be useful as, among other applications, a mildewstat or mildewcide in architectural coatings along with other conventional coating ingredients including binders, pigments, extenders, and the like. In some approaches, the zinc aluminate as described herein may be used in architectural coatings similar to the wax-coated or in place of the wax-coated zinc oxide as described in PCT/US2022/079697, which is incorporated by reference herein.

Without wishing to be limited by theory, it is believed that the release of zinc ions from the spinel oxides (e.g., zinc aluminate) and the high surface area of zinc aluminate in particular makes releasing the ions efficient and may indicate longer sustained antimicrobial properties in architectural coating. In other circumstances, a physical mechanism of protection may also be possible with the spinel oxides herein; however, this may not be as applicable within a coating (depending on the type of coating). For instance, one possible mechanisms of action in this context may be physical damage to microorganisms due to rough, sharp surfaces of the zinc aluminate. In other approaches, the photocatalytic release of active oxygen species of the spinel oxides herein and, in particular, zinc aluminate, through exposure to UV light may also be beneficial as a mildewstat and/or mildewcide in architectural coatings. When used in architectural coatings, the spinel oxides herein, and particular, the zinc aluminate are substantially free of wax, and preferably, free of any wax coatings as described above.

As used herein and within the context of architectural coatings, mildew resistance is measured on a dried coating obtained from a 1 inch nylon brush applied by two coats on both sides of a pine or birch substrate (about 350 ft/gallon) at room temperature (25° C.) and room humidity and dried for 4 days at the room temperature and humidity, then pre-weathered for 3 weeks pursuant to ASTM G154-4, with cycles of 4 hour irradiance at 0.89 W/m²*nm with a UVA-340 bulb and 4 hours condensation cycle at 50° C. and then aged in a mildew cabinet pursuant to ASTM D3273. Mildew resistance is then assessed visually by percentage mildew defacement of the coating surface.

### Removable Closure

The coating compositions herein are also especially useful for use on the interior surface, or at least a portion thereof, of removable or screw-type closures, such as those meant to seal the opening of a variety of containers or bottles as detailed above. In many embodiments, the closures are removable from and, optionally, replaceable onto the container. Examples of such removable closures include twist-off closures for food packages, including cans, bottles, etc., and single use containers such as the pull off closures on beverage containers, etc. The coating compositions protect the coated substrate against staining (e.g., yellowing or black spots), corrosion, moisture damage, acid damage, alkaline damage, and/or other chemical or physical damage such as damage caused by the contents of the container. They also impart coating hardness. Many embodiments would be suitable for prolonged food and beverage contact, making corresponding coatings useful for protecting food and beverage containers. Additionally, the coating compositions herein exhibit excellent substrate, inter-layer (if any), and gasket adhesion. The coating compositions also demonstrate a balance of flexibility and hardness that allows them to be applied to a substrate sheet (e.g., a metal sheet). After coating, the coated sheet may then be formed into a desired shape (e.g., via stamping), such as a twist-off closure, without undue loss (if any) of adhesion to sheet or a loss of inter-layer adhesion. The coating compositions herein are particularly suited for providing corrosion resistance to chromium-free metal substrates, but may be used on other metal substrates as well depending on the application.

The removable closure is typically fabricated, as already discussed above, from a hexavalent chromium-free metal substrate, a metal substrate that has not been passivated using a chromium containing composition or, alternatively, a chromium-treated metal substrate or, having an interior and an exterior surface with one or more coatings as described herein applied on at least a portion of the interior surface of the substrate.

The coating(s) for the removable closure is derived from the coating compositions as described above including ingredients comprising the one or more above-described film-forming binder resins and the above-described inorganic sulfur-species scavenging component. The applied coating may be a coating system including a single layer or multiple layers (such as a first and second layer of the above-described coating compositions). In one approach, the removable closure includes a first and second coating of the coating composition herein applied to at least a portion of the interior surface of the substrate and wherein any embodiment of the coating composition described above is provided in either the first coating, the second coating, or both the first and second coating.

The coating systems herein of the first, second, or both layers having the sulfur-species scavenging particles in one or more of the first, second, or both layers protect the metal substrates of the removable closures, particularly chromium-free metal substrates, against reacting with food or beverage components, liquid chemicals, other components of a liquid coating composition, or elements of a food or the beverage.

In other embodiments, the present disclosure also provides methods that include “causing” any embodiment of the interior coatings and/or the coating compositions as described herein to be used on a metal substrate (or portion thereof) of a metal food or beverage container or packaging container. In some cases, where multiple parties are involved, a first party (e.g., the party that manufactures and/or supplies the food or beverage container coating composition) may provide instructions, recommendations, or other disclosures about the food or beverage container coating composition end use to a second party (e.g., a metal coater (e.g., a sheet coater for food bodies or food can ends), can maker, or brand owner). Such disclosures may include, for example, instructions, recommendations, or other disclosures relating to coating a metal substrate for subsequent use in forming packaging containers or portions thereof, coating a metal substrate of pre-formed containers or portions thereof, preparing coating compositions for such uses, cure conditions or process-related conditions for such coatings, or suitable types of packaged products for use with resulting coatings. Such disclosures may occur, for example, in technical data sheets (TDSs), safety data sheets (SDSs), regulatory disclosures, warranties or warranty limitation statements, marketing literature or presentations, or on company websites. A first party making such disclosures to a second party shall be deemed to have “caused” any embodiment of the coating compositions herein to be used on a metal substrate of metal packaging (e.g., a container or closure) even if it is the second party that actually applies the composition to a metal substrate in commerce, uses such coated substrate in commerce on a metal substrate of packaging containers, and/or fills such coated containers with product.

In embodiments, removable closures and/or hexavalent chromium-free substrates thereof and with the coating systems herein, when exposed to a test food simulant having about 95% water, about 4% acetic acid, about 0.5 weight percent sodium chloride, and about 0.05% sodium thiosulfate and then autoclaved for 30 minutes at 100° C. and placed in an oven at 35° C. for at least 3 weeks, have little to no corrosion, discoloration, and/or surface bubbling as further demonstrated in the Examples below. Corrosion ratings may be defined by those in Table 1 below and such closures of the present disclosure having a first coating of about 8 to about 9 gsm (grams per square meter—applied to the substrate) and a second coating of about 8 to about 9 gsm (applied to the first coating) with the coatings including the binders and sulfur-species scavenging particles herein in either the first, second, or both coatings (each coating baked at 200° C. for 12 minutes) and, when subjected to the test food simulant described above and stored at 35° C. for at least 3 weeks have a corrosion level of about 4 or less, about 3 or less, about 2 or less, about 1, or 0. Such corrosion levels are achieved on both chromium-free and chromium-treated substrates.

TABLE 1
corrosion ratings.

| Corrosion Level | Rating | Description |
|---|---|---|
| Very advanced | 8-10 | Bubbles on the whole flat area, corrosion |
| | | points, blackening |
| Advanced | 5-7 | Some corrosion points, presence of bubbles |
| | | on a large part of the flat area |
| Some | 2-4 | Few corrosion points or bubbles, either on |
| | | the flat area or at the featheredge |
| No corrosion | 0-1 | No corrosion at all, no bubble, no corrosion |
| | | point |

In embodiments, exemplary coating compositions for the coating systems herein include those of Table 2 below describing general and preferred compositions for a topcoat and/or a sizecoat (e.g., basecoat wherein size coat and basecoat are interchangeable) for removable closures.

TABLE 2
Exemplary Compositions for First (base) and/or
Second (top) Layers for a Removable Closure

| | Topcoat | Topcoat | Sizecoat | Sizecoat |
|---|---|---|---|---|
| | General | Preferred | General | Preferred |
| | (wt %) | (wt %) | (wt %) | (wt %) |
| Polyester resin | 20-70 | 20-70 | 10-30 | 10-30 |
| Phenolic resin | 0-20 | 2-20 | 0-25 | 15-20 |
| Urea-formaldehyde resin | 0-5 | 0.5-3 | 0-5 | 0.5-3 |
| Acrylic Resin | 0-5 | 0.5-3 | 0-5 | 0.5-3 |
| Polyolefin Resin | 0-5 | 0.5-3 | 0-5 | 0.5-3 |
| Epoxy Resin | 0-5 | 0.5-3 | 0-5 | 0.5-3 |
| TiO₂ | 10-20 | 0.5-3 | 2-15 | 0.5-3 |
| PVC | 0-50 | 20-50 | 0-50 | 20-50 |
| Polyolefin wax | 0-5 | 2-5 | 0-5 | 2-5 |
| Blocked isocyanate | 0-5 | 1-4 | 0-5 | 1-4 |
| Silicone anti foam | 0-1 | 0.02-0.5 | 0-1 | 0.02-0.5 |
| Solvent mixture | 10-60 | 5-20 | 10-60 | 40-60 |
| Inorganic sulfur-species | 1-20 | 1-20 | 1-20 | 1-20 |
| scavenging component | | | | |
| Total | 100 | 100 | 100 | 100 |

### EXAMPLES

The following examples are illustrative of exemplary embodiments of the disclosure. In these examples, as well as elsewhere in this application, all ratios, parts, and percentages are by weight unless otherwise indicated. It is intended that these examples are being presented for the purpose of illustration only and are not intended to limit the scope of the invention disclosed herein. The following examples evaluate corrosion on closures coated with two-coat coating systems and, in some instances, retorted and/or exposed to a food simulant for prolonged periods of time.

Zinc aluminate was evaluated in the following examples for suitability as an inorganic sulfur-species scavenging component. The zinc aluminate (1340DX5, SSNano) used in these evaluations had the following characteristics
Composition: 2 wt % Al₂O₃ doped ZnO
D50: 0.5 to 1.5 um (microns)
D90: less than 5 um (microns)
Specific Surface Area: 22 m²/g
   The following comparative (F1) and inventive coating compositions (C1 and C2) were prepared:

| | F1 | C1 | C2 |
|---|---|---|---|
| Solvent mixture* | 47.7% | 45.9% | 45.4% |
| Polyester resin** | 20.5% | 21.2% | 21.0% |
| TiO2 | 15.2% | 15.7% | 15.6% |
| Wax | 0.34% | 0.35% | 0.35% |
| Phenolic resins | 16.3% | 16.8% | 16.6% |
| Zinc Aluminate*** | — | 0.1% | 1.0% |

*Aromatic 100 solvent
**Evonik L912
***1340DX5 from SSnano

The above coatings F1, C1, and C2 were used as size coats (layer 1 or a base coat) along with the following complementary coatings (wt %) used as topcoats (layer 2) to prepare dual-layer systems:

| | F2 | F3 |
|---|---|---|
| Polyester resins | 21.6% | 45.8% |
| Solvent mixtures | 33.9% | 25.4% |
| TiO₂ | 15.9% | 21.1% |
| PVC | 22.6% | — |
| Wax | 1.0% | 2.1% |
| Phenolic resins | 4.5% | — |
| Urea-formaldehyde | — | 1.1% |
| Blocked isocyanate | — | 4.3% |
| Polyacid crosslinker | 0.5% | — |
| Surfactant | — | 0.2% |

For the Examples below, panels were manually coated using a wire-wound bar-coater on passivated metal panels. Each coating was applied at 8 to about 9 gsm and each coating was baked at 200° C. for 12 minutes. The various grades of metal used where the following:

| | M1 | M2 | M3 |
|---|---|---|---|
| Passivation | Chromium P311 | CFPA 555 | CFPA 555 |
| Temper | TH 580 | TH 550 | TH 620 |
| Metal thickness | 0.16 | 0.2 | 0.17 |
| Tin gauge | 2.8/2.8 | 2.8/2.8 | 2.0/2.0 |
| (g/m²) | | | |
| Supplier | ARCELOR | RASSELSTEIN | RASSELSTEIN |

Coated panels were shaped into twist-off closures and used to close jars, containing food simulants having the following compositions:

| Components | L1 | 1.2 |
|---|---|---|
| Water | 95% | 91% |
| Acetic acid | 4.0% | 4.5% |
| Salt | 0.50% | 4.50% |
| Na₂S₂0₅ | 0.052% | — |

The closed jars then received a thermal treatment in a counter-pressured autoclave featuring a heating step, a sterilization step at plateau temperature and a cooling step, with the following settings:

| | | Heating | Sterilization | Cooling |
|---|---|---|---|---|
| Plateau | Plateau | pressure | pressure | pressure |
| Time | Temperature | (bar) | (bar) | (bar) |
| 30 minutes | 100° C. | 1.4 | 1.7 | 1.4 |

The jars were then stored at incubation temperatures between 35° C. and 40° C. for several weeks or months, as detailed in each specific example thereafter. Jars were periodically pulled from the incubators and rated for corrosion using the rating system:

| | Rating | details |
|---|---|---|
| Very advanced | 8-10 | bubbles on the whole flat area*, corrosion |
| corrosion | | points, blackening |
| Advanced | 5-7 | some corrosion points, presence of bubbles |
| corrosion | | on a big part of the flat area* |
| Small corrosion | 2-4 | few corrosion points or bubbles, either on |
| | | the flat area* or at the featheredge** |
| No corrosion | 0-1 | no corrosion at all, no bubble, no corrosion |
| | | point |

*flat area: part of a closure without mechanical deformations
**feather-edge: part of a closure delimiting the flat area and the groove in which the compound forming gasket is set

The coatings described above were then combined into Coating Systems identified as S1 to S12 according to the table below. Each is identified as comparative or inventive. Film weight range for each layer is shown in the table below. The baking sequence for each layer was coded with E (external) and/or I (internal) to illustrate the numberofbakes each coatingwas being exposed to. For instance, sequence lIE in the table below means that both internal coatings were applied first, each being baked in turn, then an additional coating was applied on the external side to allow cap fabrication. In this sequence, the sizecoat or basecoat (i.e., first layer) was baked three times and the topcoat (i.e., second layer) was baked twice. Baking conditions are 200 C for 10 to 12 minutes PMT (peak metal temperature).

| | | | Dry Film Weight (gsm) | | | |
|---|---|---|---|---|---|---|
| | Layers | | Internal | Internal | | |
| | 1 | 2 | Layer 1 | Layer 2 | Sequence | |
| S1 | F1 | F2 | 7.5-8.5 | 7.5-8.5 | IIE | Compare |
| S2 | F2 | F2 | 11.5-12.5 | 13.5-14.5 | IIE | Compare |
| S3 | C1 | F2 | 7.5-8.5 | 7.5-8.5 | IIE | Inventive |
| S4 | C1 | F2 | 11.5-12.5 | 13.5-14.5 | IIE | Inventive |
| S5 | C2 | F2 | 7.5-8.5 | 7.5-8.5 | IIE | Inventive |
| S6 | C2 | F2 | 11.5-12.5 | 13.5-14.5 | IIE | Inventive |
| S7 | F1 | F3 | 7.5-8.5 | 7.5-8.5 | IEI | Compare |
| S8 | F1 | F3 | 11.5-12.5 | 13.5-14.5 | IEI | Compare |
| S9 | C1 | F3 | 7.5-8.5 | 7.5-8.5 | IEI | Inventive |
| S10 | C1 | F3 | 11.5-12.5 | 13.5-14.5 | IEI | Inventive |
| S11 | C2 | F3 | 7.5-8.5 | 7.5-8.5 | IEI | Inventive |
| S12 | C2 | F3 | 11.5-12.5 | 13.5-14.5 | IEI | Inventive |

### Example 1

The impact of the passivation on the effect of zinc aluminate on the metal substrate was evaluated using Inventive sample S6 and Comparative coating system S2. Testing conditions and results are provided below.

Testing Conditions

| Incubation | | |
|---|---|---|
| temp. | Filled simulant | Substrate |
| 35° C. | L1 | M1 or M2 |

| Substrate | Incubation (weeks) | S6 | S2 |
|---|---|---|---|
| M2 | 3 | 0 | 7 |
| M2 | 5.5 | 3 | 10 |
| M1 | 3 | 2 | 0 |
| M1 | 5.5 | 9 | 1 |

The addition of zinc aluminate to the sizecoat (S2 v. S6) increases coating's corrosion resistance when applied on M2 (CFPA). The opposite behavior can be seen on M1 (P311) with this simulant.

### Example 2

The impact of the zinc aluminate concentration on the metal substrate was evaluated with comparative coating system S1 and Inventive coating systems S4 and S6. Test conditions and results are provided below.

Conditions

| Incubation | | |
|---|---|---|
| temp. | Filled food | Substrate |
| 40° C. | Gherkins | M2 |

| Incubation | | | |
|---|---|---|---|
| (months) | S2 | S4 | S6 |
| 2 | 2 | 1 | 1 |
| 3 | 5 | 5 | 2 |
| 4 | 10 | 7 | 2 |

Conditions

| Incubation | | |
|---|---|---|
| temp. | Filled food | Substrate |
| 35° C. | L1 | M2 |

| Incubation | | | |
|---|---|---|---|
| (weeks) | S2 | S4 | S6 |
| 3 | 7 | 2 | 0 |
| 5.5 | 10 | 6 | 3 |

On CFPA-passivated metal and with real food (gherkins), the higher the quantity of zinc aluminate is added to the sizecoat (S4 had 0.1% and S6 had 1%), the better the corrosion resistance. Simulant L1 at 35° C. is more aggressive than the real food at 40° C.

### Example 3

The effect of the nature of the coatings (i.e., PVC in top or no PVC in topcoat) on the impact of the zinc aluminate on metal substrates was evaluated with Comparative coating systems S1 and S8 and Inventive coating systems S6 and S12. Conditions are results are shown in the tables below.

Conditions

| Incubation | | |
|---|---|---|
| temp. | Filled food | Substrate |
| 35° C. | L1 | M2 |

| Incubation | | | | |
|---|---|---|---|---|
| weeks | S2 | S6 | S8 | S12 |
| 3 | 7 | 0 | 2 | 2 |
| 5.5 | 10 | 3 | 7 | 7 |

The nature of the topcoat plays a role for the barrier behavior of the metal oxide. For instance, an increase of the corrosion resistance can be seen on M2 substrate with PVC containing system. S2 and S6 included PVC in the top coat. No effect is shown when added to a system that did not contain PVC. S8 and S12 did not include PVC in the top coat.

### Example 4

The effect of zinc aluminate concentrate based on the simulate/filled food and coating film weights was evaluated for Comparative coating systems S1 and S2 as well as Inventive coating systems S3, S4, S5, and S6. Conditions and results are shown below.

Conditions

| Incubation | | |
|---|---|---|
| temp. | Filled food | Substrate |
| 35° C. | L1 | M2 |
| 40° C. | L2 | M2 |
| 35° C. | Gherkins | M2 |

Simulate L1 and Gherkins were compared in high film weight situations. In general, adding more zinc aluminate reduces corrosion resistance. Corrosion under simulant L1 and gherkins test conditions are generally correlated. Results are shown below.

| Incubation | | |
|---|---|---|
| Time | Gherkins | L1 |
| T1 | 2 Months | 3 weeks |
| T2 | 3 Months | — |
| T2 | 4 Months | 5.5 weeks |

| Incubation | Gherkins | | | L1 | | |
|---|---|---|---|---|---|---|
| Time | S2 | S4 | S6 | S2 | S4 | S6 |
| T1 | 2 | 7 | 1 | 7 | 2 | 0 |
| T2 | 8 | 5 | 2 | — | — | — |
| T3 | 10 | 7 | 2 | 10 | 6 | 3 |

Simulate conditions L1 and L2 were also compared in low film weight situations. Higher corrosion protection was achieved with simulant L1 (containing SO₂) almost compensating for the film weight difference. In the absence of SO2, the effect of zinc aluminate is more detrimental when low film weights are being used. Results are provided in the tables below.

| Incubation | | |
|---|---|---|
| Time | L2 | L1 |
| T1 | 2 Months | 3 weeks |
| T2 | 3 Months | — |
| T2 | 4 Months | 8 weeks |

| Incubation | Gherkins | | | L1 | | |
|---|---|---|---|---|---|---|
| Time | S1 | S3 | S5 | S1 | S3 | S5 |
| T1 | 3 | 3 | 4 | 5 | 3 | 2 |
| T2 | 3 | 3 | 7 | — | — | — |
| T3 | 5 | 7 | 10 | 8 | 8 | 5 |

All patents, patent applications, and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A packaging container, or a portion thereof, comprising:
a metal substrate; and
an interior coating applied on at least a portion of the metal substrate, the interior coating formed from a coating composition including one or more film-forming binder resins and one or more inorganic metallic sulfur-species scavenging components.

2. The packaging container, or a portion thereof, of claim 1, wherein the one or more inorganic sulfur-species scavenging components have at least one of: (i) a water solubility at a pH of 5 or less and at 25° C. of less than about 10 mg/liter and/or (ii) a water solubility at a pH of 5 or less (e.g., pH of 5) and at 25° C. at least 10-fold lower than the water solubility of zinc oxide.

3. The packaging container, or a portion thereof, of claim 1, wherein the inorganic metallic sulfur-species scavenging component includes zinc and, optionally, at least one secondary metal selected from aluminum, titanium, tin, and/gr iron.

4. The packaging container, or a portion thereof, of claim 1, wherein the inorganic metallic sulfur-species scavenging component is a spinel oxide of the general structure AB₂O₄ wherein A is a divalent metal ion and B is at least one metal ion having a valence greater than 2.

5. The packaging container, or a portion thereof, of claim 3, wherein the inorganic metallic sulfur-species scavenging component includes a zinc ferrite, a zinc aluminate, a zinc titanate, or a combination thereof.

6. (canceled)

7. The packaging container, or portion thereof, of claim 1, wherein the inorganic metallic sulfur-species scavenging component is substantially free of wax coatings.

8. The packaging container, or portion thereof, of claim 1, wherein the metal substrate includes a metal substrate that has not been passivated using a hexavalent chromium containing composition, a trivalent chromium containing composition, or any chrome-based compositions and wherein the metal substrate is pretreated with a pretreatment composition comprising a zirconium compound and one or more optional polymers.

9. (canceled)

10. The packaging container, or portion thereof, of claim 1, wherein the metal substrate is part of a removable closure (including a twist-off closure.

11. (canceled)

12. (canceled)

13. (canceled)

14. The packaging container, or portion thereof, of claim 1, wherein the inorganic metallic sulfur-species scavenging component has a distribution of particle sizes with the smallest particle in the distribution being greater than 100 nm as measured by laser diffraction and wherein the inorganic metallic sulfur-species scavenging component has a D50 distribution of particle sizes of about 2 microns or less.

15. (canceled)

16. The packaging container, or portion thereof, of claim 1, wherein the inorganic metallic sulfur-species scavenging component has a surface area of about 1 m²/g to about 40 m²/g as determined by ASTM D3037.

17. (canceled)

18. The packaging container, or portion thereof, of claim 1, wherein the coating composition, based on total nonvolatile weight, has at least about 0.01 weight percent of the inorganic metallic sulfur-species scavenging component, and wherein the coating composition, when dried as a coating on the interior surface of the substrate, has about 10 weight percent or less of the inorganic metallic sulfur-species scavenging component.

19. (canceled)

20. (canceled)

21. The packaging container, or portion thereof, of claim 1, further including a first and a second coating applied to at least a portion of the interior surface of the substrate and wherein the interior coating from the coating composition is either the first coating, the second coating, or both the first and the second coating and wherein one of the first coating, the second coating or both has a concentration of the inorganic sulfur-species scavenging component within a surface region of the respective dried coating greater than a concentration of the inorganic metallic sulfur-species scavenging component within a central region of the respective dried coating.

22. (canceled)

23. (canceled)

24. (canceled)

25. The packaging container, or portion thereof, of claim 21, wherein the second coating is a PVC organosol including a thermoplastic polyvinyl chloride (PVC) polymer, one or more stabilizers (for the PVC), and one or more crosslinkers, and optionally one or more other binder polymers.

26. The packaging container, or portion thereof, of claim 1, further including a sealing gasket and wherein the sealing gasket is a polyvinylchloride-containing sealing gasket, a polyolefin-containing sealing gasket, and/or a polyester-containing sealing gasket.

27. (canceled)

28. The packaging container, or a portion thereof, of claim 2, wherein the interior coating, when contacted with an aqueous test solution including 4 weight percent acetic acid, 0.5 weight percent sodium chloride, and 0.052 weight percent sodium metabisulfite and heated for 30 minutes at 100° C. and then stored at 35° C. for 7 weeks (while still contacting the aqueous test solution), the aqueous test solution has no more than 5 ppm of zinc from the inorganic sulfur-species scavenging component, wherein zinc concentration may be determined by inductively coupled plasma mass spectrometry (ICP-MS).

29. (canceled)

30. (canceled)

31. The packaging container, or portion thereof, of claim 1, wherein the interior coating, after baking has a delta E color change of about 10 or less.

32. (canceled)

33. The packaging container, or portion thereof, of claim 1, wherein the coating composition, based on total resin weight, includes about 10 to about 70 weight percent polyester resin, at least about 5 weight percent of crosslinker.

34. The packaging container, or a portion thereof, of claim 33, wherein the coating composition includes about 0.1 to about 20 weight percent of the inorganic sulfur-species scavenging component.

35. (canceled)

36. (canceled)

37. (canceled)

38. The coating composition of claim 1.

39. (canceled)

40. (canceled)

41. (canceled)

42. (canceled)

43. (canceled)

44. A method comprising causing the coating composition of claim 38 to be used on a metal substrate for a food or beverage container or a portion thereof.
